(19) United States
(12) Patent Application Publication
(10) Pub. No.: US 2009/0132109 A1
(43) Pub. Date: May 21, 2009

(54) Method and Control Device Recognising, Specific to a Driver, Inattentiveness of a Driver of a Vehicle

(75) Inventors: Lars Galley, Dettenhausen (DE); Elisabeth Hendrika Hentschel, Magstadt (DE); Klaus-Peter Kuhn, Pluederhausen (DE); Wolfgang Stolzmann, Dissen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/916,885

(22) PCT Filed: Jun. 1, 2006
(86) PCT No.: PCT/EP2006/005215

§ 371 Date: Jul. 16, 2008

(30) Foreign Application Priority Data
Jun. 9, 2005 (DE) 10 2005 026 457.3

(51) Int. Cl. G08B 21/06

(52) U.S. Cl. 701/29

(57) ABSTRACT

A method and a device are provided for detecting when the driver of a motor vehicle becomes inattentive. A steering inactivity phase and a subsequent steering action are detected in this context. A steering inactivity phase is detected if the absolute value of the steering wheel angle, of its change over time, or both, during a predefined time threshold value, does not exceed a first threshold value. A steering action is detected if the absolute value of the steering wheel angle, of its change over time, or both, exceeds a second threshold value. The first threshold value and the second threshold value are modified in a driver-specific fashion.

### BACKGROUND AND SUMMARY OF THE INVENTION

This invention relates to a method for detecting when the driver of a motor vehicle becomes inattentive. Furthermore, the invention relates to a control unit for detecting inattentiveness of the driver of a vehicle.

Japanese document JP 09 123 790 A discloses a method in which the driver's state is monitored by comparing the steering speed distribution and the frequency of steering movements with set reference values. The reference values are determined at the start of a journey.

Japanese document JP 07 093 678 A discloses a method for detecting tiredness of the driver of a vehicle in which a steering inactivity phase and a subsequent steering action are detected.

Taking this prior art as a basis, the object of the invention is to make available a method and a control unit for carrying out the method which permit more reliable detection of possible inattentiveness.

This object is achieved by means of the features of the invention claimed.

In methods as claimed, a steering inactive phase and a subsequent steering action are detected. A steering inactivity phase is detected when the steering wheel angle and/or its change over time remain within a first threshold value in absolute terms during the period of a predefined time threshold value. This means that the steering wheel angle and/or its change over time do/does not exceed the first threshold value in absolute terms during the period of the predefined time threshold value. In the detection of inattentiveness of the driver, the invention differentiates between the steering inactivity phase and a more or less violent steering action which typically follows in a state of inattentiveness. A steering action is detected if the steering wheel angle and/or of its change over time exceed/exceeds a second threshold value in absolute terms immediately after the steering inactivity phase.

The first threshold value of the steering wheel angle and/or of its change over time and the second threshold value of the steering wheel angle and/or of its change over time can advantageously be modified in a driver-specific fashion. This permits precise warning of inattentiveness taking into account different steering behaviors for different drivers.

The predefined time threshold value can also advantageously be modified in a driver-specific fashion. This permits the detection of inattentiveness to be made more precise by taking into account individual differences in the steering behavior of different drivers.

The second threshold value of the steering wheel angle and/or of its change over time are/is advantageously larger than the first threshold value of the steering wheel angle and/or of its change over time.

In one advantageous development of the invention, the driver-specific first threshold value and the driver-specific second threshold value are acquired at the start of a journey during a predetermined time period. This permits the acquisition of the driver-specific threshold values at a time at which the driver of the vehicle has certainly not yet become tired.

The predetermined time period in which the driver-specific threshold values are acquired is advantageously divided into time intervals. This permits an iterative method which operates with values which have been acquired in each case in two subsequent time intervals. A time interval is here, for example, the time interval between two zero positions of the steering wheel speed. Alternatively, the time interval has, for example, a fixed length.

In one advantageous development of the invention, an iterative method is used to determine the driver-specific parameters, in particular the first threshold value of the steering wheel angle and/or of its change over time, and the second threshold value of the steering wheel angle and/or of its change over time, or a predefined time threshold value. In this context, the determination is advantageously carried out using acquired values which have been acquired during a current time interval, and acquired values which have been acquired during the time interval which precedes the current time interval.

This has the advantage that there is no need to store further signals from the past. In this context, the determination of the first threshold value of the steering wheel angle and/or of its change over time and the determination of the second threshold value of the steering wheel angle and/or of its change over time is carried out using the iterative method. In a subsequent step, the determination of the predefined time threshold value can be carried out using the first threshold value of the steering wheel angle and/or of its change over time.

The method for detecting inattentiveness therefore permits, through the use of driver-specific parameters, a higher detection rate with lower noise and fewer false alarms.

Further advantageous refinements of the method are also claimed.

The abovementioned object of the invention is also achieved by means of a control unit for carrying out the described method. The advantages of this solution correspond to the advantages mentioned above with respect to the described method.

### BRIEF DESCRIPTION OF THE DRAWINGS

FIG. 1 shows a control unit according to the invention; and

FIG. 2 shows graphs by means of which the sequence of the method is explained by way of example.

### DETAILED DESCRIPTION OF THE INVENTION

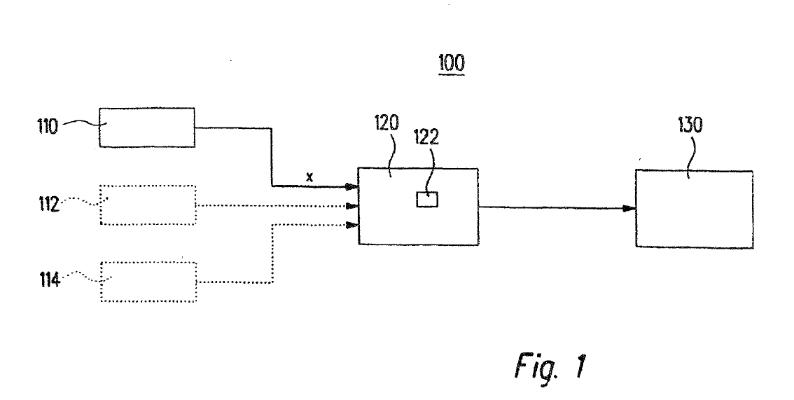

FIG. 1 shows a control unit 100 for carrying out the method according to the invention, for detecting inattentiveness of the driver of a vehicle, in particular of a motor vehicle. The control unit is mounted in the vehicle and comprises a steering wheel angle sensor 110 for sensing the current steering wheel angle x, that is to say the steering movement caused by the driver. Furthermore, the control unit 100 comprises a control device 120 which is preferably embodied as a microcontroller. The control device 120 senses a sensor signal which is generated by the steering wheel angle sensor 110 and which represents the steering wheel angle x.

The steering wheel angle x represents a first preferred indicator of inattentiveness of the driver. In addition to the steering wheel angle, the control device 120 can basically also receive and evaluate further sensor signals from other sensors 112, 114 as further indicators of the inattentiveness of the driver.

In order to detect inattentiveness of the driver, a computer program 122 runs on the control device 120 and detects the inattentiveness according to a method described below by evaluating the steering wheel angle x as an indicator. If inattentiveness of the driver is detected, it is advantageous if the control device 120 actuates a warning device 130 so that the latter outputs an acoustic or visual warning message to the driver. Owing to the warning message, the driver is made aware of his inattentive behavior as he is driving the vehicle and he is given an opportunity to become attentive again.

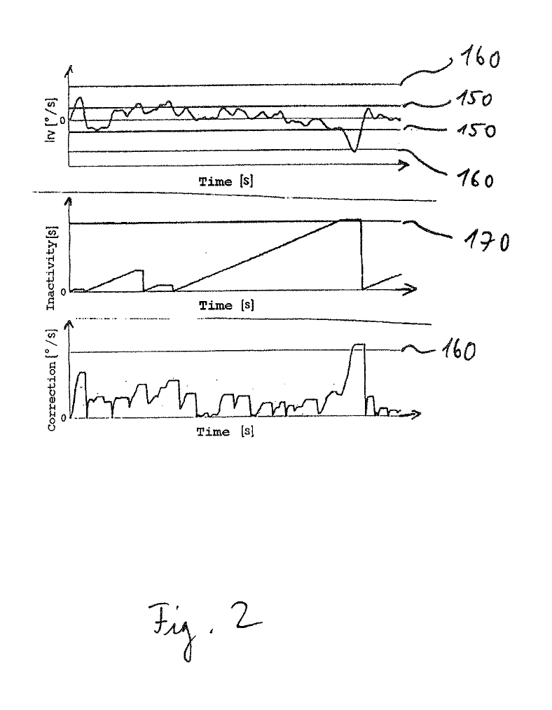

In the illustration in FIG. 2, the method according to the invention is described by way of example by reference to the steering wheel angle speed lrv. As an alternative to the steering wheel angle speed, the steering wheel angle lrw can also be considered.

The tiredness-related and/or distraction-related steering patterns which are considered here are composed of a steering inactivity phase and a subsequent violent steering correction. A steering inactivity phase occurs if the steering wheel angle speed lrv is smaller in absolute terms than the first threshold value of the steering wheel angle speed θ_{inact} during the predefined time threshold value θ_{inact}_{_{—}}ₜ.

If the steering wheel angle speed of the steering action which directly follows the steering inactivity phase exceeds in absolute terms the second threshold value of the steering wheel angle speed θₑᵥₑₙₜ then the steering action in this case is violent. Expediently, in this context, the first threshold value of the steering wheel angle speed-inact is smaller than the second threshold value of the steering wheel angle speed-event. In FIG. 2, the first threshold value of the steering wheel angle speed-inact is designated by the reference number 150. The second threshold value of the steering wheel angle speed-event is designated by the reference number 160, and the predefined time threshold value θ_{inact}_{_{—}}ₜ is designated by the reference number 170.

There are a number of possible ways of determining whether a steering action directly follows an inactivity phase. For example, a fixed time period of, for example, 500 ms to 1 sec subsequent to the steering inactivity phase can be considered. If a steering action occurs in this fixed time period, it is considered as immediately after the steering phase. On the other hand, it is possible, for example, to consider the time in which the steering wheel is moved in one direction, that is to say up to the first steering wheel stationary state after the steering inactivity phase, that is to say up to the time at which the steering wheel angle speed first becomes zero after the steering inactivity phase.

In the text that follows, a case is described in which the immediately following steering action is defined as the time up to the first steering wheel stationary state after the steering inactivity phase. Through suitable modifications of the function inactivity (t,θ_{inact}) and in the function correction(t) this also functions for a fixed time period of 500 ms to 1 sec. Given further suitable modifications of the functions, the method also functions for further definitions of the time period in which a steering action is subsequently considered as immediate to a steering inactivity phase.

The formulas which are represented in the text which follows represent exemplary functions with which the parameters can be defined in a driver-specific fashion.

In the case of the function inactivity(t) which is represented in central graphs in FIG. 2, an inactivity phase occurs if inactivity(t,θ_{inact})>θ_{inact}_{_{—}}ₜ is true.

$$Inactivity ( 0 , {θ}_{inact} ) = 0$$

$$Inactivity ( t , {θ}_{inact} ) = \{ \begin{matrix}Inactivity ( t - 1 , {θ}_{inact} ) + 1 , & \begin{matrix}if \vert lrv ( t - 1 ) \vert < \\ {θ}_{inact} ⋀ \vert lrv ( t ) \vert < {θ}_{inact}\end{matrix} & \\ 0 & \begin{matrix}if \vert lvr ( t - 1 ) \vert \geq \\ {θ}_{inact} ⋀ \vert lrv ( t ) \vert < {θ}_{inact}\end{matrix} & \\ Inactivity ( t - 1 , {θ}_{inact} ) , & \begin{matrix}if \vert lvr ( t ) \vert \geq {θ}_{inact} ⋀ \\ sign ( lrv ( t - 1 ) ) = \\ sign ( otherwise lvr ( t ) ) 0 ,\end{matrix} & otherwise\end{matrix}$$

In the lower graphs in FIG. 2, an exemplary profile of the function correction(t) is illustrated. A steering action or steering correction occurs here if correction (t)>θₑᵥₑₙₜ is true.

$$Correction ( 0 ) = 0 , \\ Correction ( t ) = \{ \begin{matrix}0 , & if sign ( lrv ( t - 1 ) ) \neq sign ( lrv ( t ) ) \\ Correction ( t - 1 ) , & \begin{matrix}if sign ( lrv ( t - 1 ) ) = \\ sign ( lrv ( t ) ) ⋀ \vert lrv ( t - 1 ) \vert \geq \vert lrv ( t ) \vert\end{matrix} \\ \vert lrv ( t ) , \vert & \begin{matrix}if sign ( lvr ( t - 1 ) ) = \\ sign ( lrv ( t ) ) ⋀ \vert lrv ( t - 1 ) < \vert lrv ( t ) \vert\end{matrix}\end{matrix}$$

Here, t−1 designates in each case the time of the respectively preceding sampling.

A steering pattern occurs if a steering action follows an inactivity phase. The steering pattern function is defined, for example, as follows

$$steering pattern ( t ) = \{ \begin{matrix}1 , & \begin{matrix}if inactivity ( t , {θ}_{inact} ) > \\ {θ}_{inact\_i} ⋀ correction ( t ) > {θ}_{event}\end{matrix} \\ 0 , & otherwise\end{matrix}$$

In all the exemplary functional profiles given, t is the time in the signal sampling rate unit. The inactivity and correction functions illustrated in FIG. 2 are related in each case to the change over time of the steering wheel angle illustrated by way of example in the top graph in FIG. 2. The first threshold value of the steering wheel angle speed θ_{inact} is entered with the reference symbol 150 in the upper graph in FIG. 2 in which the steering wheel angle speed is illustrated. This first threshold value is driver-specific. The second threshold value of the steering wheel angle speed is entered with the reference symbol 160 in the upper graph in FIG. 2 in which a profile of the steering wheel angle speed is entered by way of example. The predefined time threshold value θ_{inact}_{_{—}}ₜ is entered with the reference number 170 in the middle graph in FIG. 2 in which the inactivity function is entered.

In an alternative embodiment of the invention, the steering wheel angle lrw can also be considered instead of the steering wheel angle speed.

The detection of a tiredness-related and/or distraction-related steering patterns/pattern therefore depends on the parameters of θ_{inact}_{_{—}}ₜ (predefined time threshold value 170), θ_{inact} (first threshold value of the steering wheel angle speed 150) and θₑᵥₑₙₜ (second threshold value of the steering wheel angle speed 160). These parameters can preferably be modified in a driver-specific fashion. This is to be preferred to defining these parameters globally and independently of a driver since different drivers can differ greatly from one another in terms of their steering behavior. The invention permits one or more of these parameters to be individualized.

For this purpose, the steering behavior of the driver is preferably evaluated at the start of a journey, during a specific time period. The specific time period is preferably divided here into time intervals. The division into time intervals can be done in various ways. For example, time intervals of 500 ms to 1 sec. in length can be considered. Alternatively, all the intervals between two successive zero points of the steering wheel angle speed can be considered.

For all these intervals, the maximum steering wheel angle speed, the maximum steering angle, the average steering angle speed and/or the length of the time interval are acquired or calculated. In one advantageous development of the invention, all these values for the intervals are acquired or calculated.

These values are averaged for the predetermined time period at the start of the journey. Furthermore, quartiles are determined for all these values. The 100% quartile is here the absolute maximum. The 50% quartile, median, is estimated by means of the mean value. The 25% quartile and the 75% quartile are preferably approximated.

The 25% quartile gives here that value which separates the lower 25% of the acquired values from the upper 75%. The 50% quartile gives that value which separates the lower 50% of the acquired values from the upper 50%, i.e. the 50% quartile is the median. The 75% quartile gives that value which separates the lower 75% of the acquired values from the upper 25%.

An example of a calculation rule for an approximation of the 25% quartile and the 75% quartile is represented in the text which follows. Here, these approximations are carried out for all the values w acquired for the intervals. The variable w can therefore relate to values of the maximum steering wheel angle speed, values of the maximum steering angle, values of the average steering angle speed and/or values of the length of the time interval.

### Step 1:

For the first n values the mean value of the values w is calculated. n is for example 100 here.

### Step 2:

For each new value w,
a. the mean value is calculated again according to the following rule:
mean=(mean*n+w)/(n+1); n=n+1
b. if w<mean, it is used to calculate the 25% quartile mean25:
mean25=(mean25*n25+w)/(n25+1); n25=n25+1
c. if w>mean, mean75 is used to calculate the 75% quartile:
mean75=(mean75*n75+w)/(n75+1); n75=n75+1

The number n25 is here the number of values w which have been used to calculate the 25% quartile mean25. The number n75 is here the number of values w which have been used to calculate the 75% quartile mean75. The initial values of n25 and n75 are zero here.

The advantage of such an approximation method of the 25% and 75% quartiles of the abovementioned values compared to directly determining the quartiles is that it is iterative. The advantage here is that there is no need for a memory to store the values w. The values w from the past therefore do not have to be recorded and stored for further processing.

In order to avoid taking into account steering events which have been caused by microsteering movements, for example due to unevennesses in the ground, only intervals in which the steering wheel angle difference is greater than a predefined third threshold value are considered for the calculation of the quartiles. A preferred value range for the third threshold value is, for example, 1° to 2°.

Therefore, the 100% quartile and 50% quartile values are available for individualizing and determining in a driver-specific fashion the parameters of the first threshold value, second threshold value and/or predefined time threshold value. In addition, the approximations for the 25% quartile and the 75% quartile are available. These four quartiles are available for a number of or for each of the parameters of the maximum steering angle speed, maximum steering angle, average steering angle speed and length of the time interval, which are acquired during the predetermined time period at the start of the journey.

The first threshold value of the steering wheel angle speed θ_{inact} 150 and the second threshold value of the steering wheel angle speed θₑᵥₑₙₜ 160 are determined as mathematical functions as a function of a subset of these, for example, 16 values.

There are a number of possibilities for this. One possible example is the following:

θ_{inact}_{_{—}}ₜ=factor1*mean25 (maximum steering angle speed)

θₑᵥₑₙₜ=factor2*mean75 (maximum steering angle speed)

The calculation of the predefined time threshold value θ_{inact}_{_{—}}ₜ 170 can be carried out in accordance with a similar method using θ_{inact} (first threshold value 150). For example, all the steering inactivity phases are determined using the first threshold value θ_{inact} 150 for the predetermined time period at the start of a journey. For the duration of these steering inactivity phases it is possible, for example, to determine the quartiles, for example, in a way which is analogous to the approximation method described above.

The predefined time threshold value θ_{inact}_{_{—}}ₜ 170 can then be calculated as a function of these quartiles. This can be done as follows, for example:

θ_{inact}_{_{—}}ₜ=factor 3*mean75 (steering inactivity phases)

If a constant function is used for an individual parameter, this parameter is not individualized, that is not set in a driver-specific fashion.

1-9. (canceled)

10. A method for detecting when a driver of a vehicle becomes inattentive, in which inattentiveness is determined as a function of a steering inactivity phase and a subsequent steering action, comprising:
detecting a steering inactivity phase when the absolute value of at least one of a steering wheel angle and a change in the steering wheel angle over time during the period of a predefined time threshold value does not exceed a first threshold value that is modifiable in a driver-specific fashion, and
detecting a steering action when the absolute value of at least one of the steering wheel angle and a change in the steering wheel angle over time exceeds a second threshold value that is modifiable in a driver-specific fashion.

11. The method as claimed in claim 10, wherein the predefined time threshold value can be modified in a driver-specific fashion.

12. The method as claimed in claim 10, wherein at least one of the first threshold value, the second threshold value, and the predefined time threshold value is determined in a driver-specific fashion during a predetermined time period at the start of a journey.

13. The method as claimed in claim 12, wherein the predetermined time period is divided into time intervals.

14. The method as claimed in claim 13, wherein at least one of the time intervals is the time period between two zero positions of the steering wheel angle speed.

15. The method as claimed in claim 13, wherein at least one of the time intervals has a fixed length.

16. The method as claimed in claim 13, wherein the method is an iterative method, and wherein at least one of the first threshold value, the second threshold value, and the predefined time threshold value is determined in a driver-specific fashion using acquired values for a current time interval and acquired values for the time interval preceding the current time interval.

17. The method as claimed in claim 16, wherein the acquired values relate to at least one of the maximum steering angle speed, the maximum steering angle, the average steering angle speed, and the length of the time interval.

18. The method as claimed in claim 11, wherein at least one of the first threshold value, the second threshold value, and the predefined time threshold value is determined in a driver-specific fashion during a predetermined time period at the start of a journey.

19. The method as claimed in claim 18, wherein the predetermined time period is divided into time intervals.

20. The method as claimed in claim 19, wherein at least one of the time intervals is the time period between two zero positions of the steering wheel angle speed.

21. The method as claimed in claim 19, wherein at least one of the time intervals has a fixed length.

22. The method as claimed in claim 19, wherein the method is an iterative method, and wherein at least one of the first threshold value, the second threshold value, and the predefined time threshold value is determined in a driver-specific fashion using acquired values for a current time interval and acquired values for the time interval preceding the current time interval.

23. The method as claimed in claim 22, wherein the acquired values relate to at least one of the maximum steering angle speed, the maximum steering angle, the average steering angle speed, and the length of the time interval.

24. The method as claimed in claim 14, wherein the method is an iterative method, and wherein at least one of the first threshold value, the second threshold value, and the predefined time threshold value is determined in a driver-specific fashion using acquired values for a current time interval and acquired values for the time interval preceding the current time interval.

25. The method as claimed in claim 15, wherein the method is an iterative method, and wherein at least one of the first threshold value, the second threshold value, and the predefined time threshold value is determined in a driver-specific fashion using acquired values for a current time interval and acquired values for the time interval preceding the current time interval.

26. The method as claimed in claim 24, wherein the acquired values relate to at least one of the maximum steering angle speed, the maximum steering angle, the average steering angle speed, and the length of the time interval.

27. The method as claimed in claim 25, wherein the acquired values relate to at least one of the maximum steering angle speed, the maximum steering angle, the average steering angle speed, and the length of the time interval.

28. A control unit for detecting inattentiveness of a driver of a vehicle, comprising:
a steering wheel angle sensor for sensing a current steering wheel angle of the vehicle,
a control unit for carrying out the method as claimed in claim 10 in response to the sensed steering wheel angle, and
a warning device for outputting at least one of an acoustic warning message and an optical warning message to the driver if inattentiveness of the driver has been detected when the method is being carried out.
